(19) United States
(12) Patent Application Publication
(10) Pub. No.: US 2025/0174853 A1
(43) Pub. Date: May 29, 2025

(54) ELECTRODE ASSEMBLY AND RECHARGEABLE BATTERY INCLUDING THE SAME

(71) Applicant: Samsung SDI Co., Ltd., Yongin-si (KR)

(72) Inventors: Hyunchul KIM, Yongin-si (KR); Junhyeok KWAK, Yongin-si (KR); Jaewon LEE, Yongin-si (KR)

(21) Appl. No.: 18/808,946

(22) Filed: Aug. 19, 2024

(30) Foreign Application Priority Data
Nov. 24, 2023 (KR) 10-2023-0166069

(51) Int. Cl. H01M 50/586; H01M 50/107

(52) U.S. Cl. CPC H01M 50/586; H01M 50/107

(57) ABSTRACT

An electrode assembly includes a first electrode including a first substrate and a first active material layer formed on a front and a back of the first substrate, respectively, a second electrode including a second substrate and a second active material layer formed on the front and the back of the first substrate, respectively, a separator between the first electrode and the second electrode, and a first insulation layer and a second insulation layer formed on the front and the back of the first substrate, respectively, and covering an end of the first active material layer, the first insulation layer and the second insulation layer having different lengths.

### CROSS-REFERENCE TO RELATED APPLICATION

The present application claims priority to and the benefit of Korean Patent Application No. 10-2023-0166069, filed on Nov. 24, 2023, in the Korean Intellectual Property Office, the entire disclosure of which is incorporated herein by reference.

### BACKGROUND

### 1. Field of the Disclosure

Aspects of the present disclosure relate to an electrode assembly and a rechargeable battery including the same.

### 2. Description of the Related Art

With advancement of technology and increasing the demand for mobile devices, demand for rechargeable batteries as energy sources has also been increasing.

Among them, a cylindrical rechargeable battery includes an electrode assembly formed by spirally winding electrodes disposed in both sides of a separator and the separator together in the shape of a jelly roll, a center pin disposed in a hollow portion in the center of the electrode assembly, a case containing the electrode assembly therein, and a cap assembly closing and sealing an opened side of the case.

In such a rechargeable battery, a swelling, a deformation, or an expansion of the negative active material layer may occur during charging and discharging, and at this time, the different polarities may be in contact with each other and a short circuit may occur.

Particularly, in the case of the cylindrical rechargeable battery, the uncoated electrode part of the electrode assembly is electrically connected to the current collector in a folded state, and in this case, and end of the uncoated electrode part of the other polarity may be placed to face the folded uncoated electrode part.

For example, when the negative active material layer expands, the uncoated electrode part of the negative electrode may be in contact with the uncoated electrode part of the folded positive electrode, thereby causing a short circuit.

The above information disclosed in this Background section is only for enhancement of understanding of the background of the invention and therefore it may contain information that does not form the prior art.

### SUMMARY

Therefore, aspects of the present disclosure are directed to an electrode assembly and a rechargeable battery that may prevent a short circuit from occurring by being in contact with the positive uncoated electrode part even if the negative active material layer expands.

According to some embodiments, there is provided an electrode assembly including: a first electrode including a first substrate and a first active material layer formed on a front and a back of the first substrate, respectively, a second electrode including a second substrate and a second active material layer formed on the front and the back of the first substrate, respectively, a separator between the first electrode and the second electrode, and a first insulation layer and a second insulation layer formed on the front and the back of the first substrate, respectively, and covering an end of the first active material layer, the first insulation layer and the second insulation layer having different lengths.

In some embodiments, the first insulation layer and the second insulation layer are bent toward a center of the electrode assembly.

In some embodiments, the first insulation layer on the front of the first substrate is shorter than a length of the second insulation layer, which is on the back of the first substrate and positioned closer to the center of the electrode assembly than the first insulation layer.

In some embodiments, a width of the second insulation layer is 5.5 mm to 5.9 mm, and a width of the first insulation layer is 2.5 mm to 2.7 mm.

In some embodiments, the first insulation layer and the second insulation layer are not formed on parts of the first substrate such that the first substrate further includes a front exposed part and a rear exposed part where the first substrate is exposed, a width of the front exposed part is more than 4.25 mm from an end of the first insulation layer, and a width of the rear exposed part is more than 1 mm from an end of the second insulation layer.

In some embodiments, the front exposed part is directly in contact with the rear exposed part of a next turn of the first substrate to be electrically connected thereto.

In some embodiments, the second insulation layer faces away from an end of the second electrode.

In some embodiments, the first insulation layer and the second insulation layer are formed of ceramic.

In some embodiments, the ceramic includes Al₂O₃.

In some embodiments, a thickness of the first insulation layer and the second insulation layer is less than 10 um.

In some embodiments, the first electrode is a positive electrode, and the second electrode is a negative electrode.

In some embodiments, a thickness of the first insulation layer and the second insulation layer is greater than a protruded size of a burr formed on an incision surface of the first electrode.

In some embodiments, a thickness of the first insulation layer and the second insulation layer is more than 20 um.

In some embodiments, the first insulation layer and the second insulation layer overlap ends of the first active material layer by less than 1 mm.

According to some embodiments, there is provided a rechargeable battery including: the electrode assembly of claim 1; a cylindrical case configured to accommodate the electrode assembly; a center pin at a center of the electrode assembly; a cap assembly that covers and seals the cylindrical case; and an electrolyte included within the cylindrical case together with the electrode assembly.

Other aspects, features, and characteristics that are not described above will be more clearly understood from the accompanying drawings, claims, and detailed description.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings.

FIG. 1 is a perspective view showing the internal structure of a rechargeable battery according to some embodiments of the present disclosure.

FIG. 2 is a cross-sectional view showing a part of an electrode assembly in FIG. 1, according to some embodiments of the present disclosure.

FIG. 3 is a cross-sectional view showing a part of an electrode assembly of FIG. 1 according to some other embodiments of the present disclosure.

FIG. 4 is a cross-sectional view showing the operational effect of preventing a short circuit during charge and discharge cycles, according to some embodiments of the present disclosure.

### DETAILED DESCRIPTION

Hereinafter, embodiments of the present disclosure will be described in detail with reference to the accompanying drawings. Terms and words used in the present specification and claims are not to be construed as a general or dictionary meaning, but are to be construed as meaning and concepts meeting the technical ideas of the present disclosure based on a principle that the present inventors may appropriately define the present disclosure as the concepts of terms in order to describe their disclosures in best mode. Therefore, the configurations described in the embodiments and drawings of the present disclosure are merely most preferable embodiments but do not represent all of the technical spirit of the present disclosure. Thus, the present disclosure should be construed as including all the changes, equivalents, and substitutions included in the spirit and scope of the present disclosure at the time of filing this application.

It should be further understood that the terms “comprise, include” and/or “comprising, including,” when used in this specification, specify the presence of stated features, integers, steps, operations, elements, and/or components, but do not preclude the presence or addition of one or more other features, integers, steps, operations, elements, components, and/or groups thereof.

In addition, the accompanying drawings may be exaggerated in dimensions of some of the components rather than drawn to scale to facilitate understanding of the present disclosure. Additionally, like reference numbers may be assigned to like components in another embodiment.

As used herein, the term “and/or” includes any and all combinations of one or more of the associated listed items. For example, the expression “A and/or B” denotes A, B, or A and B. Expressions such as “one or more of” and “at least one of,” when preceding a list of elements, modify the entire list of elements and do not modify the individual elements of the list. For example, the expression “one or more of A, B, and C,” “at least one of A, B, or C,” “at least one of A, B, and C,” and “at least one selected from the group consisting of A, B, and C” indicates only A, only B, only C, both A and B, both A and C, both B and C, or all of A, B, and C.

Further, the use of “may” when describing embodiments of the inventive concept refers to “one or more embodiments of the inventive concept.” Also, the term “exemplary” is intended to refer to an example or illustration.

Although the terms “first”, “second”, and the like are used to describe various constituent elements, these constituent elements are not limited by these terms. These terms are used only to distinguish one constituent element from another constituent element, but it is not limited thereto, the first constituent elements described below may be the second constituent elements within the technical spirit of the present disclosure.

Throughout the specification, unless otherwise stated, each component may be singular or plural.

As shown in the drawings, spatially relative terms, such as “beneath,” “below,” “lower,” “under,” “above,” “upper,” and the like, may be used herein for ease of explanation to describe one element or feature's relationship to another element(s) or feature(s) as illustrated in the drawing. It should be understood that spatially relative positions are intended to encompass different orientations of the device in use or in operation, in addition to the orientations depicted in the drawings. For example, if the device in the drawings is turned over, elements described as “below,” “beneath,” or “under” other elements or features would then be oriented “above” the other elements or features. Thus, the term “down” can encompass both an orientation of above and below.

Additionally, if a component is described as “on,” “connected to,” or “coupled to” another component, the components may be directly connected or connected to each other, but it should be understood that other components may be “interposed” between each component, or that each component may be “connected,” “coupled,” or “connected” through other components.

The terms used herein are intended to describe embodiments of the present disclosure and are not intended to limit it.

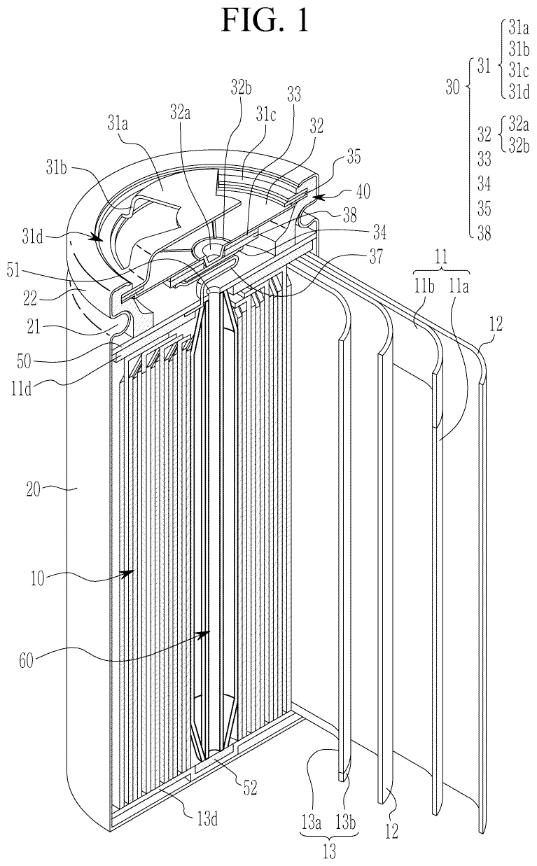

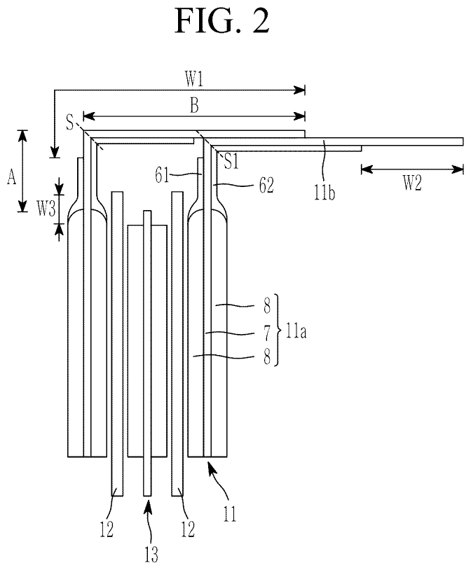

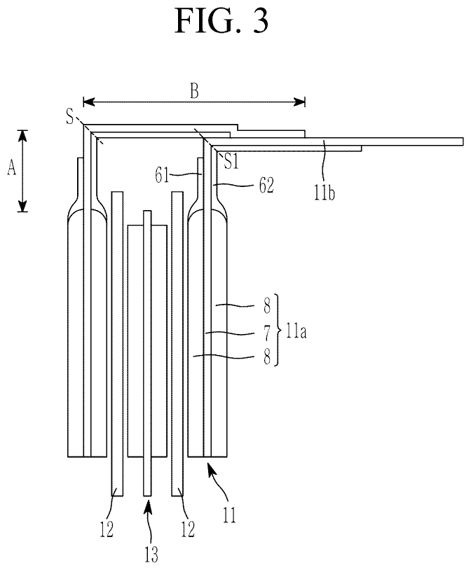

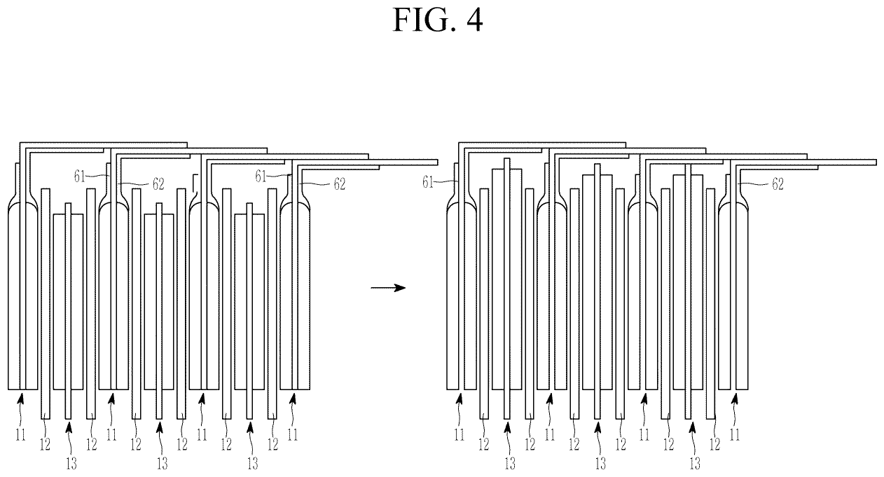

FIG. 1 is a cross-sectional view of a rechargeable battery according to some embodiments of the present disclosure. FIG. 2 is a cross-sectional view showing a part of an electrode assembly in FIG. 1, according to some embodiments of the present disclosure. FIG. 3 is a cross-sectional view showing a part of an electrode assembly of FIG. 1 according some other embodiments of the present disclosure. FIG. 4 is a cross-sectional view showing the operational effect of preventing a short circuit during charge and discharge cycles, according to some embodiments of the present disclosure.

As shown in FIG. 1, a rechargeable battery according to some

embodiments includes an electrode assembly 10, a case 20 for accommodating the electrode assembly 10, a cap assembly 30 coupled to the opening of the case 20 via a gasket and electrically connected to the electrode assembly 10, an insulating plate 50 interposed between the cap assembly 30 and the electrode assembly 10, and a center pin 60 placed at the center of the electrode assembly 10.

The electrode assembly 10 includes a first electrode 11, a separator 12, and a second electrode 13 that are sequentially stacked. The electrode assembly 10 may be a cylindrical jelly roll formed by stacking the first electrode 11, the separator 12, and the second electrode 13 and then winding them around the center pin 60.

The separator 12 is placed between the first electrode 11 and the second electrode 13 and insulates them. For example, the separator 12 may include polyethylene, polypropylene, polyvinylidene fluoride, or a multilayer structure of two or more layers thereof. The separator 12 may also include a mixed multilayer structure such as a polyethylene/polypropylene two-layer structure, a polyethylene/polypropylene/polyethylene three-layer structure, or a polypropylene/polyethylene/polypropylene three-layer structure.

The first electrode 11 and the second electrode 13 include coated regions 11a and 13a where an active material layer is formed on both sides of a current collector formed of a thin metal plate, and uncoated regions 11b and 13b where the active material layer is not formed and the current collector substrate is exposed. The uncoated regions 11b and 13b are at opposite ends of the current collector, respectively. In some examples, the first electrode 11 may be a positive electrode, and the second electrode 13 may be a negative electrode.

In the jelly roll state, the first electrode current collecting plate 11d is connected to a first uncoated region 11b of the electrode assembly 10, and the second electrode current collecting plate 13d is connected to the second uncoated region 13b of the electrode assembly 10.

While the second electrode current collecting plate 13d is in contact with the case 20, the first electrode current collecting plate 11d is formed to be narrower than the second electrode current collecting plate 13d, so that the first electrode current collecting plate 11d is formed not to be in contact with the case 20.

Referring to FIG. 1 and FIG. 2, the uncoated region 11b of the first electrode 11 is bent toward the center pin 60, which is the center of the electrode assembly 10, and the neighboring first uncoated regions 11b may overlap each other and be stacked to be electrically connected.

The first uncoated region 11b may be electrically connected to the first electrode current collecting plate 11d with the overlapped state.

The first uncoated region 11b includes one surface that is electrically connected by being in contact with the first electrode current collecting plate 11d and another surface facing the end of the second electrode 13. The other surface is spaced apart from the end of the second electrode 13.

A first insulation layer 61 and a second insulation layer 62 of different lengths L1 and L2 are formed on one surface and on the other surface of the first uncoated region 11b, respectively. The lengths L1 and L2 are lengths extending from the end of the first insulation layer 61 and the second insulation layer 62, respectively, that are adjacent to (e.g., meet) the first coated region 11a to the end of the first uncoated region 11b that is exposed to the outside. The length L1 of the first insulation layer 61 may be shorter than the length L2 of the second insulation layer 62.

For example, the length L1 of the first insulation layer 61 may be about 2.5 mm to about 2.7 mm, and the length L2 of the second insulation layer 62 may be about 5.5 mm to about 5.9 mm.

The thickness of the first insulation layer 61 and the second insulation layer 62 may be less than 10 μm to facilitate laser notching to form the electrode uncoated region (or an electrode tab); however, embodiments of the present disclosure are not limited thereto.

The first insulation layer 61 and the second insulation layer 62 may be thicker than (e.g., the combination may be thicker than) the size of a burr generated during a punching to form the electrode uncoated region (or the electrode tab) of the first electrode, or punching or a laser process for notching between the electrode uncoated regions. For example, if the size of the burr is 15 μm, the first insulation layer 61 and the second insulation layer 62 may together be 20 μm or more.

The first uncoated region 11b includes a first region A, which extends from the first coated region 11a in a first direction (e.g., longitudinal direction of the electrode assembly 10/case 20), and a second region B, which extends (e.g., is bent) from the first region A (e.g., in a second direction crossing the first direction) and overlaps the neighboring first uncoated region 11b. For better understanding and ease of description, the first region A and the second region B can be divided by an imaginary line S, as shown in FIG. 2.

The first insulation layer 61 is formed in the first region A, the second insulation layer 62 is formed from in and the first region A to the second region B. The end of first insulation layer 61 is positioned on the imaginary line S where the first uncoated region 11b is bent, or below the imaginary line S. Due to the second insulation layer 62 formed in the first region A, a short circuit with the second uncoated region 13b may be prevented.

In order for the first uncoated region 11b to be electrically connected to the neighboring first uncoated regions 11b, the second insulation layer 62 is formed only in a portion of the second region B, forming an exposed surface where the other surface of the first uncoated region 11b is exposed. In other words, the second insulation layer 62 may be formed from the line S to the line S1 of the neighboring first uncoated region 11b.

The width W1 of the front exposed surface formed on one surface of the first uncoated region 11b may be more than 4.25 mm, and the width W2 of the rear exposed surface formed on the other surface of the first uncoated region may be more than 1 mm.

In some examples, the first insulation layer 61 and the second insulation layer 62 may be formed of ceramic, an NMP solvent is used as a solution, and the content of a solid Al₂O₃ may be changed up to about 13% to about 30% depending on the thickness of the first insulation layer 61 and the second insulation layer 62.

In FIG. 2, it is illustrated that the second insulation layer 62 is formed up to the line S1 of the neighboring first electrode 11, but it is not limited to this, and as shown in FIG. 3, the end of the second insulation layer 62 may be positioned beyond the line S1 of the neighboring first electrode 11.

The thickness of the first uncoated region 11b is thin and it bends easily, and the height of the second insulation layer 62 is low, so the first uncoated region 11b may be easily bent along the end of the second insulation layer 62 and cover the end of the second insulation layer 62. Therefore, even if the second insulation layer 62 is positioned between the first uncoated region 11b and the neighboring first uncoated region 11b, the neighboring first uncoated region 11b may be easily contacted and electrically connected.

The first coated region 11a includes a substrate 7 and an active material layer 8 formed on the substrate 7. The first insulation layer 61 and the end of active material layer 8 adjacent to the second insulation layer 61 are covered with the first insulation layer 61 and the second insulation layer 62.

The end of the active material layer 8 has a slope that is inclined with respect to the substrate 7, and the first insulation layer 61 and the second insulation layer 62 may be formed on the slope of the active material layer 8. By covering the slope of the active material layer 8 with the insulation layers 61 and 62, the thickness of the slope may be compensated to reduce the thickness deviation at the center and edges of the active material layer.

In some examples, the first insulation layer 61 and the second insulation layer 62 may overlap with the active material layer 8, which may have a width W3 of 1 mm or less. If the overlapped width W3 of the insulation layers exceeds 1 mm, an end of the overlapped width W3 may pass over the slope of the active material layer 8 and may be located on a part with the uniform thickness of the active material layer 8. As a result, protruded areas in the form of steps or mountains due to the insulation layer occur locally, which may fracture the areas where the adjacent electrode plates overlap.

Referring to FIG. 4, when the first insulation layer 61 and the second insulation layer 62 are formed as in some embodiments, even when the active material layer 8 of the second electrode 13 expands during the charge and discharge cycles and the second uncoated region 13b is protruded (e.g., bulges), the top of the second uncoated region 13b comes into contact (T) with the second insulation layer 62, so a short circuit does not occur.

Again referring to FIG. 1, a lead tab 37 is electrically connected to the first electrode current collecting plate 11d.

One end of the lead tab 37 may be connected to the first electrode current collecting plate 11d by welding, and the other end may be electrically connected to the cap assembly 30. The lead tab 37 may be bent so that one surface faces the electrode assembly 10 to increase the contact area with the cap assembly 30.

An insulating plate 50 with an opening exposing the center pin 60 is positioned above the first electrode current collecting plate 11d.

The insulating plate 50 may be formed larger (e.g., formed to have a larger diameter) than the first electrode current collecting plate 11d, so that the insulating plate 50 may be in contact with the inner surface of the case 20. In this way, when the insulating plate 50 is formed larger than the first electrode current collecting plate 11d, a certain gap is formed between the first electrode current collecting plate 11d and the case 20 as the width of the insulating plate 50 protrudes past (e.g., is protruded out of) the first electrode current collecting plate 11d. The gap between the first electrode current collecting plate 11d and the case 20 may prevent a phenomenon in which the first electrode current collecting plate 11d and the case 20 come into contact with one another and become short-circuited.

The lead tab 37 may be connected by being in contact with a first auxiliary plate 34 of the electrode assembly 10, which will be described later, through the opening 51 of the insulating plate 50.

Because the electrode assembly 10 is wound around the center pin 60, the center pin 60 may be positioned at the center of the electrode assembly 10 and be arranged parallel to the direction in which the electrode assembly 10 is inserted into the case 20 (e.g., longitudinal direction of the electrode assembly 10/case 20).

The center pin 60 is insignificantly (e.g., minimally) deformed or maintains a shape close to a shape thereof before a deformation when being subjected to an overall compressive load or a local impact load acting from the outside of the rechargeable battery.

The center pin 60 may be formed of a material with a certain rigidity, for example, a conductive metal, in order to be insignificantly (e.g., minimally) deformed against the external impact. Like this, because the center pin 60 has the conductivity, both ends of the center pin 60 are installed to maintain an electrically insulated state on the first electrode current collecting plate 11d and the second electrode current collecting plate 13d.

That is, an insulating pad 52 is placed between the bottom of the center pin 60 and the second electrode current collecting plate 13d corresponding thereto. The top of the center pin 60 penetrates a through hole formed in the center of the first electrode current collecting plate 11d in an insulated state and is supported on the insulating plate 50. Here, the top of the center pin 60 may be spaced apart from the through hole of the first electrode current collecting plate 11d, and an insulating member may be interposed between them. Therefore, the movement of the center pin 60 in the length direction of the center pin 60 is restricted, and the center pin 60 may be maintained in a stable state at the center of the electrode assembly 10.

The case 20 has an opening on one side so that the electrode assembly 10 with an electrolyte may be inserted, and may be formed to have approximately the same shape as the jelly roll-shaped electrode assembly 10. For example, the case 20 may be cylindrical.

The case 20 may be connected to the second electrode current collecting plate 13d of the electrode assembly and act as a second electrode terminal of the rechargeable battery. In some examples, the case 20 may be formed of a conductive metal such as aluminum, an aluminum alloy, or nickel-plated steel.

The electrode assembly 10 may be inserted into the case 20 together with the electrolyte solution and then sealed.

The electrolyte solution may be composed of organic solvents such as ethylene carbonate (EC), propylene carbonate (PC), diethyl carbonate (DEC), dimethyl carbonate (DMC), and ethyl methyl carbonate (EMC), and lithium salts such as LiPF6 and LiBF4. The electrolyte solution may be liquid, solid, or gel-like.

The cap assembly 30 is positioned in the opening of the case 20 and is coupled to the case 20 with a gasket 40 in between. The gasket 40 insulates the case 20 and the cap assembly 30, and closes and seals the inside of the case 20, which holds the electrode assembly 10 and the electrolyte solution.

The cap assembly 30 includes a cap plate 31, a positive temperature coefficient element 35, a vent plate 32, an insulation member 33, a first auxiliary plate 34, and a second auxiliary plate 38.

The first auxiliary plate 34 may be electrically connected to the lead tab 37 of the electrode assembly, and may be coupled to the lead tab 37 by welding.

The second auxiliary plate 38 may be stacked on the first auxiliary plate 34 and be electrically connected to the first auxiliary plate 34, and may be connected to the first auxiliary plate 34 by welding. The second auxiliary plate 38 may be disposed at the center of the electrode assembly 10 corresponding to the center pin 60 to have a through hole exposing the first auxiliary plate 34.

The vent plate 32 is disposed above the second auxiliary plate 38 with the insulation member 33 therebetween. The edge of the vent plate 32 may be inserted into the gasket 40 to be coupled to the case 20.

The vent plate 32 includes a vent 32a disposed at a portion corresponding to the center pin 60. The vent 32a protrudes from the vent plate 32 toward the electrode assembly 10, and is electrically connected to the first auxiliary plate 34 by being in contact therewith through the through hole. The vent plate 32 may have a notch 32b around the vent 32a to guide breakage of the vent 32a.

The vent 32a may cut off the electrical connection with the first auxiliary plate 34 by being broken under a set or predetermined pressure condition to release an internal gas to the outside. That is, when the internal pressure of the case 20 rises due to the generation of the gas, the notch 32b may be quickly broken to allow the gas to be discharged to the outside through an exhaust port 31d to be described later, thereby preventing the rechargeable battery from exploding.

In addition, when the vent 32a is broken due to an abnormal reaction (e.g., an abnormal chemical reaction), the electrical connection between the vent plate 32 and the first auxiliary plate 34 is broken. Accordingly, the electrical connection between the cap plate 31 electrically connected to the vent plate 32 and the first auxiliary plate 34 is broken, and thus no more current flows.

The cap plate 31 includes a center plate 31a corresponding to the center pin 60 which is the center of the electrode assembly 10, a plurality of branch portions 31b extending from the center plate 31a toward the gasket 40, and a coupling plate 31c inserted and coupled into the gasket 40 to connect ends of the branch portions 31b. The exhaust port 31d is formed between adjacent branch portions 31b, which are opened to the outside.

The branch 31b is connected to the center plate 31a in a bent state from the coupling plate 31c so that a center of the cap plate 31 can protrude to the outside of the case 20. The cap plate 31 may be electrically connected to the positive collector plate 11d through the vent plate 32, the second auxiliary plate 38, the first auxiliary plate 34, and the lead tab 37, so as to be used as a positive terminal of the rechargeable battery. Therefore, the connection with a terminal of an external device may be facilitated by forming the center of the cap plate 31 to protrude to the outside of the case 20.

The positive temperature coefficient element 35 may be formed along a second plate of the cap plate 31, and may be inserted and coupled into the gasket 40 while being stacked between the second plate of the cap plate and an edge of the vent plate.

The positive temperature coefficient element 35 may be installed between the cap plate 31 and the vent plate 32 to control a current flow between the cap plate 31 and the vent plate 32 depending on an internal temperature of the rechargeable battery.

When the internal temperature is within a set or predetermined range, the positive temperature coefficient element 35 acts as a conductor to electrically connect the cap plate 31 and the vent plate 32. If the internal temperature exceeds the set or predetermined temperature, the positive temperature coefficient element 35 has electrical resistance that can dramatically increase (e.g., increase to a very large value). As a result, the positive temperature coefficient element 35 may block the flow of a charged or discharged current between the cap plate 31 and the vent plate 32.

With the electrode assembly 10 inserted into case 20, the cap assembly 30 is inserted into the gasket 40 in the form in which the vent plate 32, the positive temperature element 35, and the cap plate 31 are stacked on the edge of the cap assembly 30, and then inserted into the opening of the case 20.

Then, the cap assembly 30 is clamped to the opening of the case 20 through a clamping process. A beading portion 21 and a crimping portion 22 may be formed on a side adjacent to the opening of the case 20. The beading portion 21 may be formed through a beading process. The beading portion 21 has a structure that is depressed in the center of the diameter direction of the case 20 from the upper side of the case 20 while the electrode assembly 10 is accommodated in the case 20, and prevents the electrode assembly 10 from moving up and down or substantially reduces such movement.

The clamping portion 22 is connected to the beading portion 21 in a structure relatively further protruding than the beading portion 21 in the diameter direction, thereby holding an outer circumferential surface, and an upper surface of the electrode assembly 10 and a lower surface connected to the outer circumferential surface of the electrode assembly 10 with the gasket 41 interposed therebetween.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

### DESCRIPTION OF SOME OF THE SYMBOLS

10: electrode assembly 11: first electrode
12: separator 13: second electrode
20: case 21: beading portion
22: clamping portion 30: cap assembly
31: cap plate 31a: center plate
31b: branch 31c: coupling plate
31d: exhaust port 32: vent plate
31a: vent 32b: notch
33: insulation member 34: first auxiliary plate
35: positive temperature coefficient element 37: lead tab
38: second auxiliary plate 40: gasket
50: insulating plate 51: opening
60: center pin 52: insulating pad
61, 62: insulation layer

What is claimed is:

1. An electrode assembly comprising:
a first electrode comprising a first substrate and a first active material layer formed on a front and a back of the first substrate, respectively;
a second electrode comprising a second substrate and a second active material layer formed on the front and the back of the first substrate, respectively;
a separator between the first electrode and the second electrode; and
a first insulation layer and a second insulation layer formed on the front and the back of the first substrate, respectively, and covering an end of the first active material layer, the first insulation layer and the second insulation layer having different lengths.

2. The electrode assembly as claimed in claim 1, wherein the first insulation layer and the second insulation layer are bent toward a center of the electrode assembly.

3. The electrode assembly as claimed in claim 2, wherein the first insulation layer on the front of the first substrate is shorter than a length of the second insulation layer, which is on the back of the first substrate and positioned closer to the center of the electrode assembly than the first insulation layer.

4. The electrode assembly as claimed in claim 3, wherein a width of the second insulation layer is 5.5 mm to 5.9 mm, and a width of the first insulation layer is 2.5 mm to 2.7 mm.

5. The electrode assembly as claimed in claim 2, wherein the first insulation layer and the second insulation layer are not formed on parts of the first substrate such that the first substrate further comprises a front exposed part and a rear exposed part where the first substrate is exposed,
wherein a width of the front exposed part is more than 4.25 mm from an end of the first insulation layer, and
wherein a width of the rear exposed part is more than 1 mm from an end of the second insulation layer.

6. The electrode assembly as claimed in claim 5, wherein the front exposed part is directly in contact with the rear exposed part of a next turn of the first substrate to be electrically connected thereto.

7. The electrode assembly as claimed in claim 2, wherein the second insulation layer faces away from an end of the second electrode.

8. The electrode assembly as claimed in claim 1, wherein the first insulation layer and the second insulation layer are formed of ceramic.

9. The electrode assembly as claimed in claim 8, wherein the ceramic comprises Al₂O₃.

10. The electrode assembly as claimed in claim 1, wherein a thickness of the first insulation layer and the second insulation layer is less than 10 um.

11. The electrode assembly as claimed in claim 1, wherein the first electrode is a positive electrode, and
wherein the second electrode is a negative electrode.

12. The electrode assembly as claimed in claim 1, wherein a thickness of the first insulation layer and the second insulation layer is greater than a protruded size of a burr formed on an incision surface of the first electrode.

13. The electrode assembly as claimed in claim 12, wherein a thickness of the first insulation layer and the second insulation layer is more than 20 um.

14. The electrode assembly as claimed in claim 1, wherein the first insulation layer and the second insulation layer overlap ends of the first active material layer by less than 1 mm.

15. A rechargeable battery comprising:
the electrode assembly of claim 1;
a cylindrical case configured to accommodate the electrode assembly;
a center pin at a center of the electrode assembly;
a cap assembly that covers and seals the cylindrical case; and
an electrolyte comprised within the cylindrical case together with the electrode assembly.
